(19) United States
(12) Patent Application Publication
(10) Pub. No.: US 2017/0265056 A1
(43) Pub. Date: Sep. 14, 2017

(54) METHOD AND ELECTRONIC DEVICE FOR INTELLIGENT INTERCONNECTION

(71) Applicants: LE HOLDINGS (BEIJING) CO., LTD., Beijing (CN); LE SHI INTERNET INFORMATION & TECHNOLOGY CORP. BEIJING, Beijing (CN)

(72) Inventor: Shiqi ZHANG, Beijing (CN)

(21) Appl. No.: 15/247,807

(22) Filed: Aug. 25, 2016

Related U.S. Application Data
(63) Continuation of application No. PCT/CN2016/089363, filed on Jul. 8, 2016.

(30) Foreign Application Priority Data
Mar. 14, 2016 (CN) 201610144217.9

(51) Int. Cl. H04W 8/02; H04W 76/02; H04L 29/08

(52) U.S. Cl. CPC H04W 8/02; H04L 67/26; H04W 76/02

(57) ABSTRACT

The present disclosure discloses a method and electronic device for intelligent interconnection. The method includes: registering push service in a push engine and establishing long connection with the push engine by a first intelligent terminal; registering finding service in a local area network by the first intelligent terminal to enable the local area network to recognize the first intelligent terminal; receiving an intelligent terminal search request and receiving selection operation on a second searched intelligent terminal by the first intelligent terminal, when the first intelligent terminal and the second intelligent terminal are not in a same local area network, transmitting registration service carrying identity information of the second intelligent terminal to the push engine by the first intelligent terminal to enable the push engine to establish a corresponding relationship of the first intelligent terminal and the second intelligent terminal, thereby realizing intelligent interconnection according to the corresponding relationship.

### CROSS-REFERENCE TO RELATED APPLICATIONS

The present disclosure is a continuation of International Application No. PCT/CN2016/089363 filed on Jul. 8, 2016, which is based upon and claims priority to Chinese Patent Application No. 201610144217.9, entitled “METHOD FOR INTELLIGENT INTERCONNECTION AND INTELLIGENT TERMINAL”, filed on Mar. 14, 2016, and the entire contents of all of which are incorporated herein by reference.

### FIELD OF TECHNOLOGY

The present disclosure generally relates to the technical field of intelligent interconnection, and in particular, to a method and an electronic device for intelligent interconnection.

### BACKGROUND

Along with development of smart phones and popularization of smart televisions, the smart phones and the smart televisions interact more and more frequently, correspondingly, users have more and more interaction requirements on interaction of the smart televisions and the smart phones, for example, watching a video searched by a smart phone on a smart television, transmitting live commenting to the smart television from the smart phone, and controlling the play progress of the video in the smart television through an intelligent terminal. Realization of various requirements of users is based on interconnection of the smart phone and the smart television, and then the smart television may be controlled and operated by the smart phone.

At present, the smart phone and the smart television are mainly interconnected in a mode that a micro image of the smart phone is projected to the smart television through a local area network in a data stream mode. To realize the interconnection scheme, the smart television and the smart phone shall be in a same local area network, and smart televisions and smart phones in different local area networks cannot be interconnected, therefore, a conventional interconnection scheme is poor in universality.

### SUMMARY

The embodiment of the present disclosure discloses a method and an electronic device for intelligent interconnection, and aims to solve the problem that a conventional interconnection scheme is poor in universality.

According to an embodiment of the present disclosure, there is provided a method for intelligent interconnection, including:

registering push service in a push engine and establishing long connection with the push engine by a first intelligent terminal;

registering finding service in a local area network by the first intelligent terminal to enable the local area network to recognize the first intelligent terminal;

receiving an intelligent terminal search request and receiving selection operation on a second searched intelligent terminal by the first intelligent terminal;

when the first intelligent terminal and the second intelligent terminal are not in a same local area network, transmitting registration service carrying identity information of the second intelligent terminal to the push engine by the first intelligent terminal to enable the push engine to establish a corresponding relationship of the first intelligent terminal and the second intelligent terminal, thereby realizing intelligent interconnection according to the corresponding relationship.

According to an embodiment of the present disclosure, there is provided an electronic device, including: at least one processor; and a memory communicably connected with the at least one processor for storing instructions executable by the at least one processor, wherein execution of the instructions by the at least one processor causes the at least one processor to:

register push service in a push engine, and establish long connection with the push engine;

find service in a local area network to enable the local area network to recognize the intelligent terminal;

receive an intelligent terminal search request and receiving selection operation on a second searched intelligent terminal;

transmit registration service carrying identity information of the second intelligent terminal to the push engine when the intelligent terminal and the second intelligent terminal are not in a same local area network to enable the push engine to establish a corresponding relationship of the intelligent terminal and the second intelligent terminal, to realize intelligent interconnection according to the corresponding relationship.

According to an embodiment of the present disclosure, there is provided a non-transitory computer-readable storage medium storing executable instructions that, when executed by an electronic device, cause the electronic device to: register push service in a push engine, and establish long connection with the push engine, find service in a local area network to enable the local area network to recognize the intelligent terminal; receive an intelligent terminal search request and receiving selection operation on a second searched intelligent terminal; transmit registration service carrying identity information of the second intelligent terminal to the push engine when the intelligent terminal and the second intelligent terminal are not in a same local area network to enable the push engine to establish a corresponding relationship of the intelligent terminal and the second intelligent terminal, to realize intelligent interconnection according to the corresponding relationship.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 shows the flow chart of steps of the method for intelligent interconnection according to some embodiments of the present disclosure.

FIG. 2 shows the flow chart of steps of the method for intelligent interconnection according to some embodiments of the present disclosure.

FIG. 3 shows the flow chart of steps of for intelligent interconnection by using the method for intelligent interconnection according to some embodiments of the present disclosure.

FIG. 4 shows the structure diagram of the intelligent terminal according to some embodiments of the present disclosure.

FIG. 5 shows the structure diagram of the intelligent terminal according to some embodiments of the present disclosure.

FIG. 6 schematically shows the structure diagram of the electronic device for executing the method according to some embodiments of the present disclosure.

FIG. 7 schematically shows a storing unit for maintaining or carrying program codes for realizing the method according to some embodiments of the present disclosure.

### DESCRIPTION OF THE EMBODIMENTS

To make the purposes, technical schemes and advantages of the embodiments of the present disclosure clearer, the technical schemes in the embodiments of the present disclosure are clearly and completely described with the following figures in the embodiments of the present disclosure, the described embodiments are not all but a part of the embodiments of the present disclosure. Based on the embodiments of the present disclosure, other embodiments obtained by a person skilled in the art under the condition that no creative work is made all belong to the protection scope of the present disclosure.

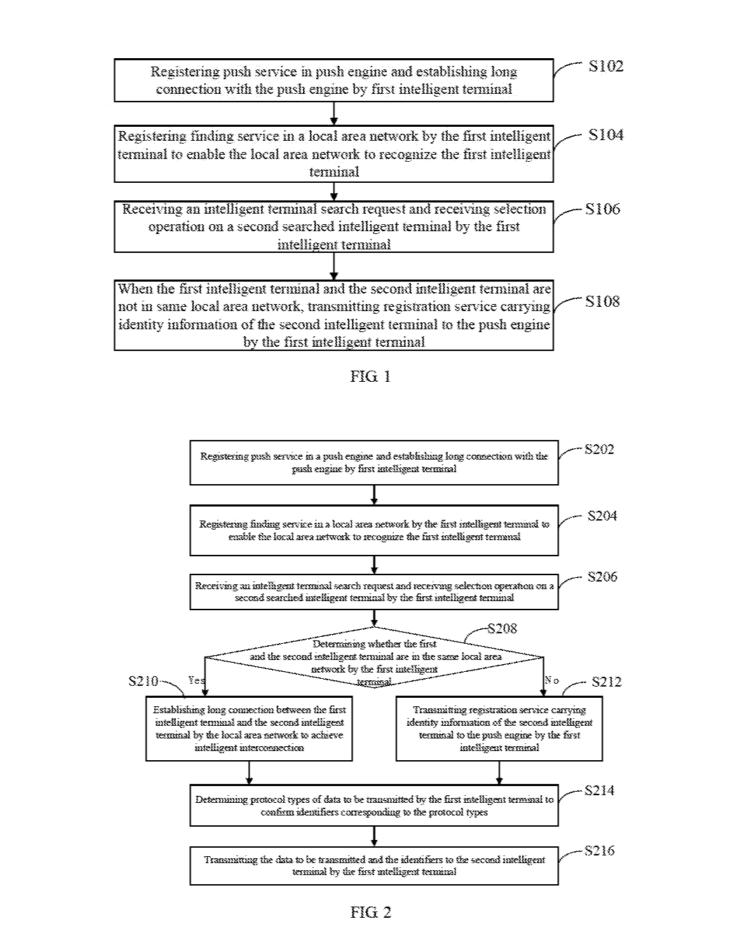

FIG. 1 shows the flow chart of steps of a method for intelligent interconnection according to some embodiments of the present disclosure.

The method for intelligent interconnection of the embodiment of the present disclosure includes the steps as follows.

In step S102, registering push service in a push engine and establishing long connection with the push engine by a first intelligent terminal.

The intelligent terminal includes but not limited to: a smart phone, a smart television, a tablet personal computer and the like.

The intelligent terminal registers the push service in the push engine when the intelligent terminal is powered on or a set application is started. The intelligent terminal registers the push service in the push engine through a login account, and after registration is completed, a corresponding relationship of the intelligent terminal and the account may be established by the push engine.

In step S104, registering finding service in a local area network by the first intelligent terminal to enable the local area network to recognize the first intelligent terminal.

The intelligent terminal registers finding service in the local area network when the intelligent terminal is powered on or the set application is started, and the local area network may obtain related information of the intelligent terminal such as a port number and a terminal name corresponding to a terminal after the finding service is successfully registered. Different intelligent terminals registering the finding service in the local area network may be recognized by the local area network in the step.

In step S106, receiving an intelligent terminal search request and receiving selection operation on a second searched intelligent terminal by the first intelligent terminal.

Triggering of the search request may be set up a person skilled in the art according to practical demands, which is not specifically restricted in the embodiment of the present disclosure. For example, a search button is arranged on an interface of the intelligent terminal, and by controlling the search button, a user may transmit the search request. After receiving the search request, the first intelligent terminal searches an intelligent terminal in a local area network same as that of the first intelligent terminal and all intelligent terminals which register a push engine same as that of the first intelligent terminal, and displays information of the searched intelligent terminals to be selected by the user, the user may select the displayed intelligent terminals, and the selected intelligent terminal is confirmed as the second intelligent terminal to be interconnected with the first intelligent terminal.

In step S108, when the first intelligent terminal and the second intelligent terminal are in different local area networks, transmitting registration service carrying identity information of the second intelligent terminal to the push engine by the first intelligent terminal.

The first intelligent terminal transmits the registration service carrying identity information of the second intelligent terminal to the push engine to enable the push engine to establish the corresponding relationship of the first intelligent terminal and the second intelligent terminal and realize intelligent interconnection according to the corresponding relationship.

As the intelligent terminal registers the push service in the push engine when the intelligent terminal is powered on or the set application is started, no matter the first intelligent terminal or the second intelligent terminal may be in long connection with the push engine, then after the push engine confirms the corresponding relationship of the first intelligent terminal and the second intelligent terminal, data to be transmitted between the first intelligent terminal and the second intelligent terminal may be transmitted through the long connection of the first intelligent terminal and the second intelligent terminal.

According to the method for intelligent interconnection provided by the embodiment of the present disclosure, the first intelligent terminal registers the push service in the push engine to enable the push engine to recognize an intelligent terminal, and the first intelligent terminal also registers the finding service in the local area network to connect the local area network and enable the local area network to recognize the first intelligent terminal. When receiving the search request, the first intelligent terminal displays an intelligent terminal in a local area network same as that of the first intelligent terminal and all intelligent terminals registering a push engine same as that of the first intelligent terminal to be selected by the user, and after the user selects one intelligent terminal, the intelligent terminal selected by the user is confirmed as the second intelligent terminal. When the first intelligent terminal and the second intelligent terminal are in a same local area network, long connection of the first intelligent terminal and the second intelligent terminal may be directly established by the local area network, when the first intelligent terminal and the second intelligent terminal are in different local area networks, the corresponding relationship of the first intelligent terminal and the second intelligent terminal is established by the push engine, and intelligent interconnection of the first intelligent terminal and the second intelligent terminal is realized by the push engine according to the corresponding relationship. It thus clear that the method for intelligent interconnection provided by the embodiment of the present disclosure is not only applicable to interconnection of intelligent terminals in a same local area network, but also applicable to interconnection of intelligent terminals in different local area networks, and is good in universality.

FIG. 2 shows the flow chart of steps of a method for intelligent interconnection according to some embodiments of the present disclosure.

The method for intelligent interconnection of the embodiment of the present disclosure includes the steps as follows.

In step S202, registering push service in a push engine and establishing long connection with the push engine by a first intelligent terminal.

The intelligent terminal includes but not limited to: a smart phone, a smart television, a tablet personal computer and the like.

Interconnection of intelligent terminals may be that of any two intelligent terminals, such as interconnection of a smart phone and a smart television, interconnection of a tablet computer and the smart television and the interconnection of the smart phone.

Local area networks in intelligent interconnection all need to register the push service in the push engine and the finding service in a local area network to enable the push engine and the local area network to recognize identities and establish network connection with the intelligent terminals respectively.

In step S204, registering finding service in a local area network by the first intelligent terminal to enable the local area network to recognize the first intelligent terminal.

When the intelligent terminal registers the finding service in the local area network, the port number and the terminal name corresponding to the intelligent terminal may be transmitted to the local area network to enable the local area network to distinguish different intelligent terminals which register the finding service. Meanwhile the local area network may also obtain information of different intelligent terminals in the local area network.

In step S206, receiving an intelligent terminal search request and receiving selection operation on a second searched intelligent terminal by the first intelligent terminal.

The user operates the first intelligent terminal to transmit the search request to the first intelligent terminal, the first intelligent terminal receives the search request, searches an intelligent terminal in a local area network same as that of the first intelligent terminal and all intelligent terminals which register a push engine same as that of the first intelligent terminal, and displays information of the searched intelligent terminals to be selected by the user, the user selects an intelligent terminal, the first intelligent terminal receives selection operation of the user and confirms the selected intelligent terminal as the second intelligent terminal interconnected with the first intelligent terminal.

In step S208, determining whether the first intelligent terminal and the second intelligent terminal are in the same local area network or not by the first intelligent terminal, if yes, implementing a step S210, and if no, implementing a step S212.

An optimal mode of determining whether the first intelligent terminal and the second intelligent terminal are in the same local area network or not is as follows:

the local area network transmits identity information of an intelligent terminal which registers the finding service in the local area network to the first intelligent terminal, the first intelligent terminal checks whether the received identity information of the intelligent terminal includes identity information of the second intelligent terminal or not, if yes, confirms that the first intelligent terminal and the second intelligent terminal are in the same local area network, and if no, confirms that the first intelligent terminal and the second intelligent terminal are in different local area networks.

In step S210, establishing long connection between the first intelligent terminal and the second intelligent terminal when the first intelligent terminal and the second intelligent terminal are in the same local area network to achieve intelligent interconnection; subsequently implementing a step S214.

As the first intelligent terminal and the second intelligent terminal are both in the local area network and are in network connection with the local area network, long connection of the first intelligent terminal and the second intelligent terminal may be established by the local area network. Specific modes for establishing long connection of intelligent terminals by the local area network are described in related technology, which are not specifically restricted in the embodiment of the present disclosure.

In step S212, when the first intelligent terminal and the second intelligent terminal are not in a same local area network, transmitting registration service carrying identity information of the second intelligent terminal to the push engine by the first intelligent terminal, and implementing the step S214.

The first intelligent terminal transmits the registration service carrying the identity information of the second intelligent terminal to the push engine to enable the push engine to establish the corresponding relationship of the first intelligent terminal and the second intelligent terminal, thereby realizing intelligent interconnection according to the corresponding relationship.

As the intelligent terminal registers the push service in the push engine when the intelligent terminal is powered on or the set application is started, no matter the first intelligent terminal or the second may establish long connection with the push engine, then after confirming the corresponding relationship of the first intelligent terminal and the second intelligent terminal, the push engine may transmit data to be transmitted between the first intelligent terminal and the second through long connection of the first intelligent terminal and the second intelligent terminal respectively. When the data are transmitted between the first intelligent terminal and the second intelligent terminal, steps S214 to S216 may be implemented.

In step S214, determining protocol types of data to be transmitted by the first intelligent terminal to confirm identifiers corresponding to the protocol types.

Different intelligent terminals to be in an interconnection relationship in the embodiment of the present disclosure all obey a preset intelligent interconnection protocol when being controlled by one another, the preset intelligent interconnection protocol specifically includes multiple protocol types, and the protocol types correspond to respective identifiers. The protocol type includes one of: a video push protocol, a like protocol, a live commenting protocol a progress control protocol and a sound control protocol.

Protocols of different types are used for processing data corresponding to different types of control operation, for example, the video push protocol is used for processing pushed video data, the like protocol is used for processing transmitted like data, and the live commenting transmitting protocol is used for processing transmitted live commenting data.

Specific identifiers corresponding to different protocol types may be set by a person skilled in the art according to practical demands, the set identifiers shall be capable of ensuring that various protocol types may be distinguished by the identifiers, which are not restricted in the embodiment of the present disclosure.

For example, an identifier A corresponds to the like protocol, when the user sends like to a program played in the second intelligent terminal from the first intelligent terminal, the first intelligent terminal generates like data according to the like operation of the user, confirms the protocol type as the like protocol, confirms that the like protocol has the corresponding identifier A, and finally transmits the like data and the identifier A to the second intelligent terminal according to the intelligent interconnection relationship.

In step S216, transmitting data to be transmitted and the identifier to the second intelligent terminal by the first intelligent terminal.

The second intelligent terminal acquires data and the identifiers after receiving the data, confirms the protocol type corresponding to the identifier, calls a protocol matching with the protocol type for analysis, and converts the data into corresponding operation which is to be executed on the second intelligent terminal.

In addition to beneficial effects of the method for intelligent interconnection described in the first embodiment, the method for intelligent interconnection provided by the embodiment of the present disclosure executes interconnection protocol agreement among interconnected intelligent terminals, distinguishes data which are to be transmitted and are of different types according to the identifiers and calls analysis protocols corresponding to the identifiers to analyze the data and the identifiers when the data and the identifiers are received by intelligent terminals receiving data, so that transmission of data of multiple protocol types may be provided, and interaction operation of multiple intelligent terminals may be supported, for example, sending like to programs, controlling program play progress and sending live commenting.

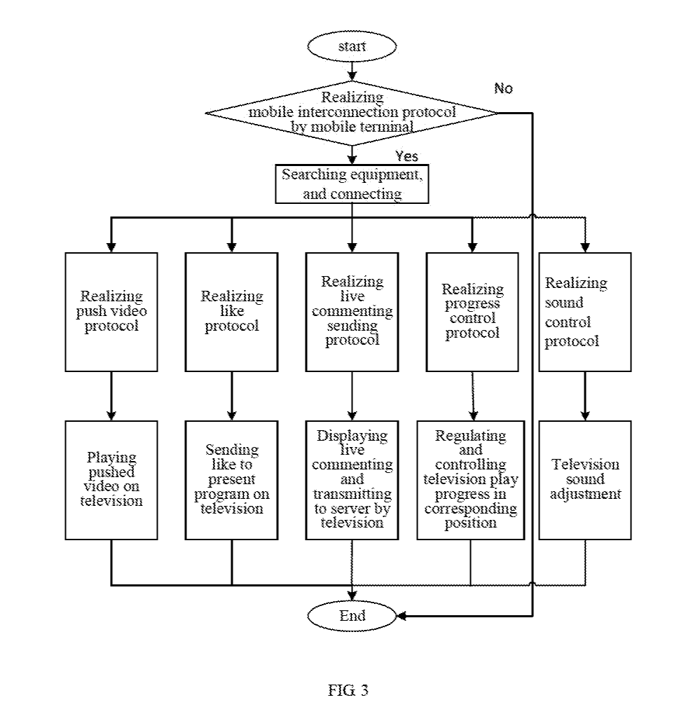

As shown in FIG. 3, the method for intelligent interconnection of the embodiment of the present disclosure is described by taking intelligent interconnection of a mobile terminal and a smart television as an example.

As shown in FIG. 3, the method for intelligent interconnection of the specific embodiment includes the following four main procedures: Procedure I, realizing a mobile interconnection protocol between the mobile terminal and the smart television.

The mobile terminal may be a mobile phone, a tablet computer and the like, and the mobile phone is taken as an example of the mobile terminal to describe the following content of the embodiment.

As the mobile terminal and the smart television of the embodiment are intelligent terminals obeying preset intelligent interconnection protocols, no matter the mobile phone or the smart television may register push service in a push engine when the mobile phone or the smart television is powered on or an application is started, establishes Transmission Control Protocol TCP long connection with the push engine, and moreover registers local area network finding service to realize interconnection protocols therebetween.

What needs to be described is that when the TCP is not successfully realized between the mobile terminal and the smart television, the whole intelligent interconnection procedure is directly terminated.

Procedure II, searching equipment and establishing connection.

A user scans equipment by clicking the mobile phone, then the mobile phone starts to search equipment and displays searched equipment information, the user clicks the searched equipment, and then connection of the mobile phone and the clicked equipment may be established.

The searched equipment in the specific embodiment is just the smart television.

If the mobile phone and the intelligent equipment are in a same local area network, TCP long connection for information transmission may be established therebetween; if the two pieces of equipment are not in a same local area network, the mobile phone transmits identity information (such as the sole identifier of the equipment) of the smart television and identity information of self to the push engine, the push engine establishes a corresponding relationship of the equipment according to the identity information of the two pieces of equipment, and data may be transmitted between the two pieces of equipment by the push engine according to the established corresponding relationship.

Procedure III, calling corresponding interconnection protocols to process data to be transmitted and transmitting to the smart television.

The mobile phone transmits data according to intelligent interconnection protocols, the intelligent interconnection protocols include multiple protocol types, and the protocol types correspond to respective identifiers. Therefore, the mobile phone needs to determine the protocol types of data to be transmitted to confirm identifiers corresponding to the protocol types and transmits the data to be transmitted and the identifiers to the smart television.

The mobile phone may execute the following operation on the smart television according to the intelligent interconnection protocol: playing videos on the smart television, controlling the play progress of a video played on the smart television at present, controlling the volume of the video played on the smart television at present, sending live commenting, sending like to the video played on the smart television, and the like.

Procedure IV, analyzing data transmitted from the mobile terminal and implementing corresponding operation by the smart television.

After receiving the data, the smart television acquires the data and the identifiers, confirms corresponding protocol types of the identifiers, calls protocols matching with the protocol types to analyze the data, and converts the data into corresponding operation which is implemented on the television, and then the purpose of controlling the smart television through the mobile phone may be achieved.

When the mobile phone pushes a video to the smart television, the smart television obeys the video push protocol to analyze pushed video data and plays the pushed video on the smart television. When the user sends like to the video played on the smart television through the mobile phone, the smart television obeys the like protocol to analyze the like data transmitted from the mobile phone and sends like to the video played at present. When the mobile phone sends live commenting data to the smart television, the smart television obeys the live commenting sending protocol to analyze the sent live commenting data, displays and transmits the analyzed live commenting to a server.

When the mobile phone transmits progress control data to the video played on the smart television at present, the smart television obeys the progress control protocol to analyze the progress control data, the analyzed progress control data are adopted to regulate and control the progress of the video played at present, and thus the play progress is regulated and controlled to a corresponding position. When the mobile phone transmits sound control data to the video played on the smart television at present, the smart television obeys the sound control protocol to analyze the sound control data, the analyzed sound control data are adopted to regulate and control the sound of the video played at present, and thus the sound of the video may be adjusted to be corresponding volume.

By adopting the method for intelligent interconnection provided by the specific embodiment, any equipment for intelligent interconnection needs to obey preset intelligent interconnection protocols, according to the preset intelligent interconnection protocols, communication amount different pieces of equipment may be achieved, and moreover the method for intelligent interconnection in the specific embodiment supports interconnection of the equipment in a same local area network and in different local area networks. Moreover, as the intelligent interconnection protocols include multiple protocol types, multiple types of interaction operation of the equipment may be supported, for example, operation such as playing video, sending live commenting, controlling video play progress, sending like to video played at present, and the like.

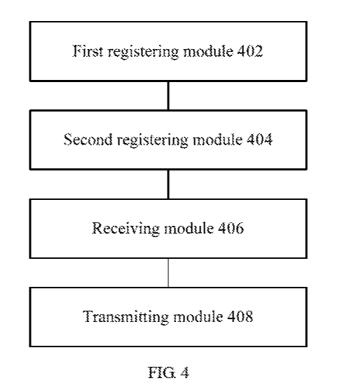

FIG. 4 shows the structure diagram of an intelligent terminal according to some embodiments of the present disclosure.

The intelligent terminal of the embodiment of the present disclosure may include a first registering module 402 for registering push service in a push engine, and for establishing long connection with the push engine; a second registering module 404 for finding service in a local area network to enable the local area network to recognize the intelligent terminal: a receiving module 406 for receiving an intelligent terminal search request and receiving selection operation on a second searched intelligent terminal; a transmitting module 408 for transmitting registration service carrying identity information of the second intelligent terminal to the push engine when the intelligent terminal and the second intelligent terminal are not in a same local area network to enable the push engine to establish a corresponding relationship of the intelligent terminal and the second intelligent terminal, thereby realizing intelligent interconnection according to the corresponding relationship.

The intelligent terminal provided by the embodiment of the present disclosure registers the push service in the push engine to enable the push engine to recognize the intelligent terminal and moreover registers the finding service in the local area network to connect the local area network and enable the local area network to recognize the intelligent terminal. When receiving a search request, the intelligent terminal displays information of a searched intelligent terminal in a local area network same as that of the intelligent terminal and all intelligent terminals registering in a push engine same as that of the intelligent terminal to be selected by a user, after the user selects one intelligent terminal, the selected intelligent terminal may be confirmed as the second intelligent terminal. When the intelligent terminal and the second intelligent terminal are in one same local area network, long connection between the intelligent terminal and the second intelligent terminal may be directly established by the local area network, and when the intelligent terminal and the second intelligent terminal are in different local area networks, a corresponding relationship between the intelligent terminal and the second intelligent terminal is established by the push engine, and intelligent interconnection of the intelligent terminal and the second intelligent terminal may be established by the push engine according to the established corresponding relationship. It is thus clear that an intelligent interconnection scheme provided by the embodiment of the present disclosure is not only applicable to interconnection of intelligent terminals in a same local area network, but also applicable to interconnection of intelligent terminals in different local area networks, and is good in universality.

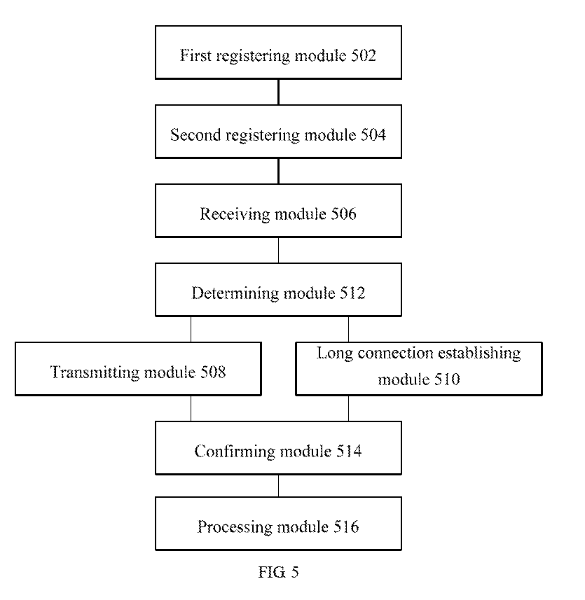

FIG. 5 shows the structure diagram of an intelligent terminal according to some embodiments of the present disclosure.

The intelligent terminal in the embodiment of the present disclosure is further optimization of the intelligent terminal in the third embodiment, and the optimized intelligent terminal may include: a first registering module 502 for registering push service in a push engine, and establishing long connection with the push engine; a second registering module 504 for finding service in a local area network to enable the local area network to recognize the intelligent terminal; a receiving module 506 for receiving an intelligent terminal search request and receiving selection operation on a second searched intelligent terminal: a transmitting module 508 for transmitting registration service carrying identity information of the second intelligent terminal to the push engine when the intelligent terminal and the second intelligent terminal are not in a same local area network to enable the push engine to establish a corresponding relationship of the intelligent terminal and the second intelligent terminal, thereby realizing intelligent interconnection according to the corresponding relationship.

Preferably, the intelligent terminal further includes a long connection establishing module 510 for establishing long connection between the intelligent terminal and the second intelligent terminal by the local area network to achieve intelligent interconnection between the intelligent terminal and the second intelligent terminal when the intelligent terminal and the second intelligent terminal are in the same local area network.

Preferably, the intelligent terminal further includes a determining module 512 for determining whether the intelligent terminal and the second intelligent terminal are in the same local area network or not after the receiving module 506 receives the selection operation of the second searched intelligent terminal.

Preferably, the intelligent terminal further includes a confirming module 514 for determining a protocol type of data to be transmitted, and for confirming an identifier corresponding to the protocol type; and a processing module 516 for transmitting the data to be transmitted and the identifier to the second intelligent terminal.

Preferably, the protocol type includes at least one of: a video push protocol, a like protocol, a live commenting protocol, a progress control protocol and a sound control protocol.

The intelligent terminal of the embodiment of the present disclosure is used for realizing the corresponding method for intelligent interconnections in the first embodiment and second embodiment, and has beneficial effects of corresponding methods in the embodiments, which is not repeatedly described.

The embodiments of the present disclosure are all described in a progressive mode, differences of the embodiments from those of others are particularly described, and refer to one another about similar parts of the embodiments. As the system of the embodiments is generally similar to the method of the embodiments, the system is relatively concisely described, see related parts in description of the method of the embodiments.

The embodiments of the device described above are only schematic, a unit which may be described as a separated part may be or not physically separated, a member for unit display may be or not a physical unit, that is, the member may be located at one place or distributed to multiple network units. A part of or all modules may be selected to achieve the purposes of the schemes of the embodiments according to practical demands. The present disclosure may be understood and implemented by a person skilled in the art without creative work.

According to the description of the embodiments, a person skilled in the art may clearly understand that the embodiments may be achieved through software together with essential universal hardware platforms, and may be definitely achieved through hardware. Based on the understanding, the technical scheme or the part contributing to the prior art may be embodied in a software product mode, the computer software product may be stored in computer readable storage mediums such as ROM/RAM, magnetic discs and optical discs with a plurality of instructions for enabling computer equipment (a personal computer, a server, network equipment and the like) to execute the embodiments or the methods described in some of the embodiments.

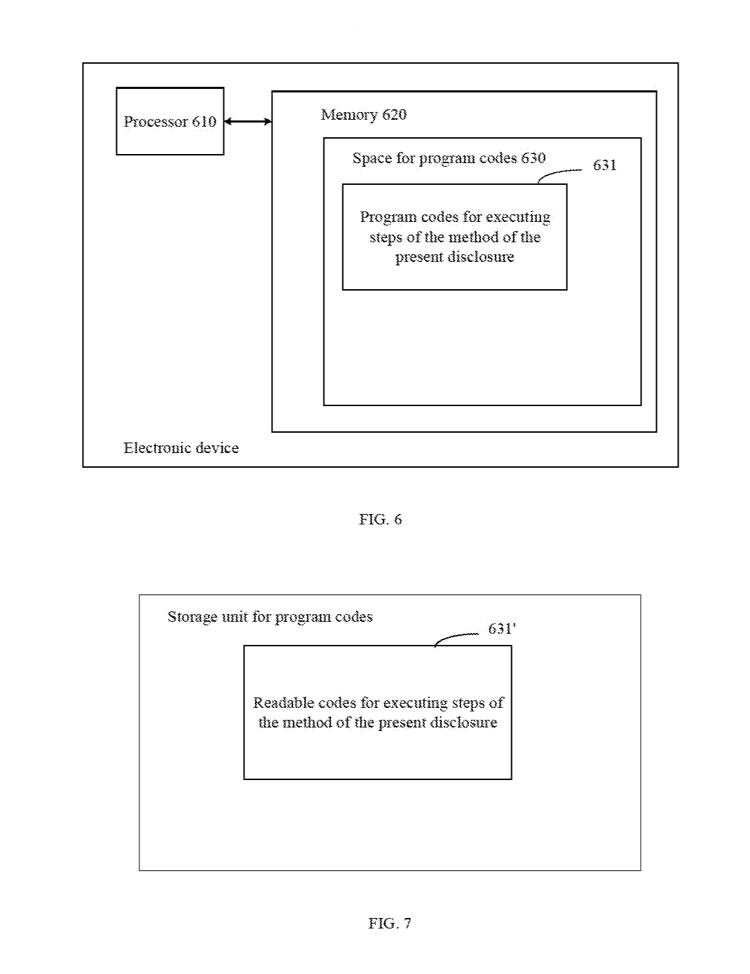

For example, FIG. 6 illustrates a block diagram of an electronic device for executing the method according the disclosure. Traditionally, the electronic device includes a processor 610 and a computer program product or a computer readable medium in form of a memory 620. The memory 620 could be electronic memories such as flash memory, EEPROM (Electrically Erasable Programmable Read-Only Memory), EPROM, hard disk or ROM. The memory 620 has a memory space 630 for executing program codes 631 of any steps in the above methods. For example, the memory space 630 for program codes may include respective program codes 631 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 7. The memory cells may be provided with memory sections, memory spaces, etc., similar to the memory 620 of the electronic device as shown in FIG. 6. The program codes may be compressed for example in an appropriate form. Usually, the memory cell includes computer readable codes 631′ which may be read for example by processors 610. When these codes are operated on the electronic device, the electronic device may execute respective steps in the method as described above.

The final description is that the embodiments are only used for describing the technical scheme of the present disclosure but not for limiting. Although the present disclosure is specifically described with reference to the embodiments, a person skilled in the art shall understand that the technical scheme recorded by each of the embodiments may be modified, or one part of technical characteristics may be equivalently replaced; and the modification or replacement does not enable the essence of the corresponding technical scheme to get out of the spirit and scope of the technical scheme in each embodiment of the present disclosure.

What is claimed is:

1. A method for intelligent interconnection, comprising:
registering push service in a push engine and establishing long connection with the push engine by a first intelligent terminal;
registering finding service in a local area network by the first intelligent terminal to enable the local area network to recognize the first intelligent terminal;
receiving an intelligent terminal search request and receiving selection operation on a second searched intelligent terminal by the first intelligent terminal;
when the first intelligent terminal and the second intelligent terminal are not in a same local area network, transmitting registration service carrying identity information of the second intelligent terminal to the push engine by the first intelligent terminal to enable the push engine to establish a corresponding relationship of the first intelligent terminal and the second intelligent terminal to realize intelligent interconnection according to the corresponding relationship.

2. The method according to the claim 1, further comprising:
establishing long connection between the first intelligent terminal and the second intelligent terminal by the local area network to achieve intelligent interconnection when the first intelligent terminal and the second intelligent terminal are in the same local area network.

3. The method according to the claim 1, after the step of receiving the selection operation on the second searched intelligent terminal, the method further comprising:
determining whether the first intelligent terminal and the second intelligent terminal are in the same local area network or not by the first intelligent terminal.

4. The method according to the claim 1, further comprising:
determining protocol types of data to be transmitted by the first intelligent terminal to confirm identifiers corresponding to the protocol types;
transmitting the data to be transmitted and the identifiers to the second intelligent terminal by the first intelligent terminal.

5. The method according to the claim 4, wherein the protocol types comprise at least one of: a video push protocol, a like protocol, a live commenting protocol, a progress control protocol and a sound control protocol.

6. An electronic device, comprising:
at least one processor; and
a memory communicably connected with the at least one processor for storing instructions executable by the at least one processor, wherein execution of the instructions by the at least one processor causes the at least one processor to:
register push service in a push engine, and establish long connection with the push engine;
find service in a local area network to enable the local area network to recognize the intelligent terminal;
receive an intelligent terminal search request and receiving selection operation on a second searched intelligent terminal;
transmit registration service carrying identity information of the second intelligent terminal to the push engine when the intelligent terminal and the second intelligent terminal are not in a same local area network to enable the push engine to establish a corresponding relationship of the intelligent terminal and the second intelligent terminal, to realize intelligent interconnection according to the corresponding relationship.

7. The electronic device according to the claim 6, wherein execution of the instructions by the at least one processor further causes the at least one processor to:
establish long connection between the intelligent terminal and the second intelligent terminal by the local area network to achieve intelligent interconnection of the intelligent terminal and the second intelligent terminal when the intelligent terminal and the second intelligent terminal are in the same local area network.

8. The electronic device according to the claim 6, wherein execution of the instructions by the at least one processor further causes the at least one processor to:
determine whether the intelligent terminal and the second intelligent terminal are in the same local area network or not after the receiving module receives the selection operation of the second searched intelligent terminal.

9. The electronic device according to the claim 6, wherein execution of the instructions by the at least one processor further causes the at least one processor to:
determine protocol types of data to be transmitted, and for confirming identifiers corresponding to the protocol types;
transmit the data to be transmitted and the identifiers to the second intelligent terminal.

10. The electronic device according to the claim 9, wherein the protocol types comprise at least one of: a video push protocol, a like protocol, a live commenting protocol, a progress control protocol and a sound control protocol.

11. A non-transitory computer readable medium storing executable instructions that, when executed by an electronic device, cause the electronic device to:
register push service in a push engine, and establish long connection with the push engine;
find service in a local area network to enable the local area network to recognize the intelligent terminal;
receive an intelligent terminal search request and receiving selection operation on a second searched intelligent terminal;
transmit registration service carrying identity information of the second intelligent terminal to the push engine when the intelligent terminal and the second intelligent terminal are not in a same local area network to enable the push engine to establish a corresponding relationship of the intelligent terminal and the second intelligent terminal, to realize intelligent interconnection according to the corresponding relationship.

12. The non-transitory computer readable medium according to the claim 11, wherein the electronic device is further caused to:
establish long connection between the intelligent terminal and the second intelligent terminal by the local area network to achieve intelligent interconnection of the intelligent terminal and the second intelligent terminal when the intelligent terminal and the second intelligent terminal are in the same local area network.

13. The non-transitory computer readable medium according to the claim 11, wherein the electronic device is further caused to:
determine whether the intelligent terminal and the second intelligent terminal are in the same local area network or not after the receiving module receives the selection operation of the second searched intelligent terminal.

14. The non-transitory computer readable medium according to the claim 11, wherein the electronic device is further caused to:
determine protocol types of data to be transmitted, and for confirming identifiers corresponding to the protocol types;
transmit the data to be transmitted and the identifiers to the second intelligent terminal.

15. The non-transitory computer readable medium according to the claim 14, wherein the protocol types comprise at least one of: a video push protocol, a like protocol, a live commenting protocol, a progress control protocol and a sound control protocol.
